(19) United States
(12) Patent Application Publication
(10) Pub. No.: US 2025/0199819 A1
(43) Pub. Date: Jun. 19, 2025

(54) CONFIGURATION OF TARGET APPLICATION ENVIRONMENT

(71) Applicant: Wells Fargo Bank, N.A., San Francisco, CA (US)

(72) Inventors: Jose Asencio, Philadelphia, PA (US); Ryan Atkins, Saint Louis, MO (US); Paulo Cesar Ayala, O’Fallon, MO (US); Daniel J. Schmitz, O’Fallon, IL (US); Jesse Updegraff, St Louis, MO (US); Jones Devlin, St. Louis, MO (US)

(21) Appl. No.: 18/543,491

(22) Filed: Dec. 18, 2023

(51) Int. Cl. G06F 9/445; G06F 9/54

(52) U.S. Cl. CPC G06F 9/44505; G06F 9/547

(57) ABSTRACT

Techniques are described for automatically configuring a target environment for a particular application or application service at an API gateway. According to the techniques, a computing device generates data representative of a user interface for display and receives a selection of a target environment for a target application from the user interface. The computing device then generates an endpoint string for service calls for the target application that indicates a route to an instance of the target application executing in the target environment. The computing devices sends a message including the endpoint string to an API gateway, wherein the message instructs the API gateway to modify an environment mapping for the target application in accordance with the endpoint string such that the environment mapping causes the API gateway to send the service calls for the target application to the instance of the target application executing in the target environment.

### TECHNICAL FIELD

This disclosure relates to computing systems and, in particular, to computing systems that manage service calls between applications.

### BACKGROUND

Software application environments provide execution environments for application development, testing, staging, and production. For example, test environments are often used by developers to perform testing and validation of an application's functionality, performance, and compatibility prior to running in an actual production environment accessible to other applications and end users. Developers use different test environments to support different types of testing.

### SUMMARY

In general, this disclosure describes techniques for automatically configuring a target environment for a particular application or application service at an application programming interface (API) gateway. The disclosed techniques include an environment selection software agent running on a computing system that is in communication with the API gateway. The environment selection agent is configured to operate as a logical switch for the API gateway to enable a user, e.g., a developer or an administrator, to select a preferred target environment from among two or more target environments in which a target application or application service is executing to send service calls for the target application or application service. The environment selection agent automatically generates an endpoint string that defines a route to an instance of the target application executing in the target environment. The environment selection agent sends the endpoint string to the API gateway and instructs the API gateway to modify an environment mapping for the target application in accordance with the route defined by the endpoint string. In this way, the disclosed techniques enable “hot swapping” of target application environments for applications accessible via the API gateway.

The environment selection agent generates data representative of a user interface for presentation to the developer or another user. The user interface may include one or more interactive components, e.g., a fillable field, drop-down menu, or the like, to enable the developer to select the preferred target environment for the target application or application service. The disclosed techniques enable developers to select different test environments to access certain test data or data scenarios stored in a particular test environment or to perform various types of testing. The disclosed techniques also enable developers to select different test and/or production environments as appropriate for different stages of the software development process, to access different external dependencies, and/or to debug production issues. Furthermore, if a non-production environment is temporarily down, users may point to a different environment as a short-term environment for testing.

In one example, this disclosure is directed to a method comprising generating, by a computing system, data representative of a user interface for display via a user device; receiving, by the computing system, a selection of a target environment for a target application from the user interface via the user device, wherein the target environment is selected from two or more application environments; generating, by the computing system, an endpoint string for service calls for the target application that indicates a route to an instance of the target application executing in the target environment; and sending, by the computing system, a message including the endpoint string to an API gateway, wherein the message instructs the API gateway to modify an environment mapping for the target application in accordance with the endpoint string such that the environment mapping causes the API gateway to send the service calls for the target application to the instance of the target application executing in the target environment.

In another example, this disclosure is directed to a computing system comprising memory and processing circuitry in communication with the memory. The processing circuitry is configured to generate data representative of a user interface for display via a user device; receive a selection of a target environment for a target application from the user interface via the user device, wherein the target environment is selected from two or more application environments; generate an endpoint string for service calls for the target application that indicates a route to an instance of the target application executing in the target environment; and send a message including the endpoint string to an API gateway, wherein the message instructs the API gateway to modify an environment mapping for the target application in accordance with the endpoint string such that the environment mapping causes the API gateway to send the service calls for the target application to the instance of the target application executing in the target environment.

In a further example, this disclosure is directed to a computer-readable storage media storing instructions that, when executed by processing circuitry, cause the processing circuitry to generate data representative of a user interface for display via a user device; receive a selection of a target environment for a target application from the user interface via the user device, wherein the target environment is selected from two or more application environments; generate an endpoint string for service calls for the target application that indicates a route to an instance of the target application executing in the target environment; and send a message including the endpoint string to an API gateway, wherein the message instructs the API gateway to modify an environment mapping for the target application in accordance with the endpoint string such that the environment mapping causes the API gateway to send the service calls for the target application to the instance of the target application executing in the target environment.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a conceptual diagram illustrating a software development system including an environment selection agent, in accordance with one or more techniques of this present disclosure.

FIG. 2 is a block diagram illustrating a computing system including an environment selection agent, in accordance with one or more aspects of the present disclosure.

FIG. 3A is a conceptual diagram illustrating an example user interface configured to allow users to select a target application and a corresponding target execution environment for the target application, in accordance with one or more techniques of the present disclosure.

FIG. 3B is a conceptual diagram illustrating an example interactive dashboard configured to allow users to select a target application and a corresponding target execution environment for the target application, in accordance with one or more techniques of the present disclosure.

FIG. 3C is a conceptual diagram illustrating an example environment mapping modification at an API gateway, in accordance with one or more techniques of this disclosure.

FIG. 4 is a block diagram illustrating an example operation of an environment selection agent in a software development system, in accordance with one or more techniques of this disclosure.

FIG. 5 is a flowchart illustrating an example operation of a computing system executing an environment selection agent, in accordance with one or more techniques of this disclosure.

Like reference characters denotes like elements throughout the text and Figures.

### DETAILED DESCRIPTION

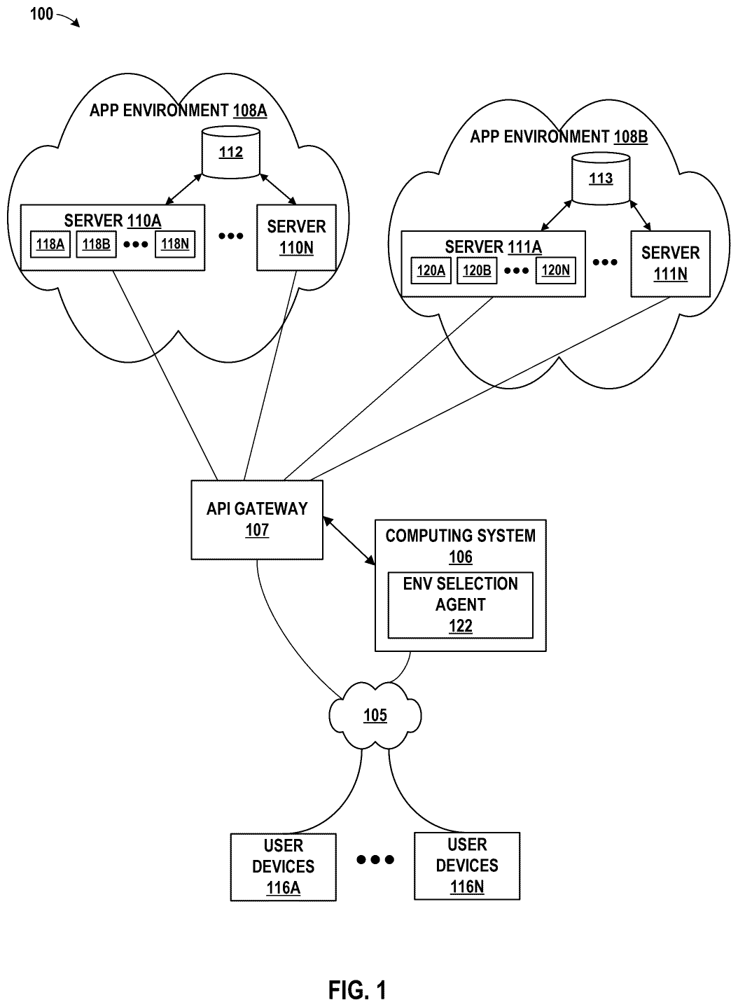

FIG. 1 is a conceptual diagram illustrating an example software development system 100 including an environment selection agent 122, in accordance with one or more techniques of this present disclosure. Software development system 100 includes representations of a number of user devices, servers, and systems capable of communicating over network 105. For example, network 105 interconnects one or more user devices 116A-116N (collectively, “user devices 116”) with one or more servers 118A-118N, 120A-120N that each execute one or more instances of applications or application services 118A-118N, 120A-120N, respectively, via an application programming interface (API) gateway 107. Network 105 may comprise one or more private or public networks, such as a private intranet of an enterprise network or the Internet. Servers 110A-110N, 111A-111N may be interconnected via network 105 within a single facility, e.g., a data center, or across multiple facilities of the enterprise network.

Software development system 100 also includes a computing system 106 executing an environment selection agent 122 that is in communication with API gateway 107 and is accessible by user devices 116 via network 105. According to the disclosed techniques, environment selection agent 122 automatically configures a target application environment for a particular application or application service at API gateway 107. In this way, the disclosed techniques enable “hot swapping” of target application environments for applications accessible via API gateway 107. Environment selection agent 122 is configured to operate as a logical switch for API gateway 107 to enable a user, e.g., an administrator or a software developer, via one of user devices 116, to select a preferred target application environment from among two or more application environments 108A-108B in which an application or application service is executing to send service calls for the application or application service.

As illustrated in FIG. 1, software development system 100 includes application environments 108A-108B (collectively “application environments 108”) of the enterprise network. Application environments 108 comprise execution environments for application development, testing, staging, and production. Each of application environments 108 are linked to different external dependencies, e.g., dependencies stored in a dependency data store 112 for application environment 108A and dependencies stored in dependency data store 113 for application environment 108B. As some examples, dependency data stores 112, 113 may include libraries, databases, file systems, or third-party systems. As illustrated, application environment 108A includes a plurality of servers 110A-110N (“servers 110”) and dependency data store 112. Application environment 108B includes a plurality of servers 111A-111N (“servers 111”) and dependency data store 113. Although illustrated in FIG. 1 as having two different application environments, in other examples, software development system 100 may include more than two application environments. For example, software development system 100 may include at least one development environment, at least two different test environments, and at least one production environment.

Servers 110 of application environment 108A or servers 111 of application environment 108B may provide a distributed execution environment for one or more applications or application services. In the illustrated example of FIG. 1, server 110A of application environment 108A hosts a plurality of instances 118A-118N (collectively, “application instances 118”) of applications or application services (e.g., microservices). Although not shown in FIG. 1, each of servers 110 within application environment 108A may host one or more application instances 118 of applications or application services. Similarly, in the illustrated example of FIG. 1, server 111A of application environment 108B hosts a plurality of instances 120A-120N (collectively, “application instances 120”) of applications or application services. Although not shown in FIG. 1, each of servers 111 within application environment 108B may host one or more application instances 120 of applications or application services. In some examples, servers 111 of application environment 108B may host application instances 120 of the same applications or application services as instances 118 hosted on servers 110 of application environment 108A. In other examples, one or more of application instances 120 hosted on servers 111 of application environment 108B may be for different applications than any of instances 118 hosted on servers 110 of application environment 108A.

Servers 110 of application environment 108A and application instances 118 executed on servers 110 have access to dependencies, e.g., libraries, databases, file systems, or third-party systems, available in dependency data store 112. Servers 111 of application environment 108B and application instances 120 executed on servers 111 have access to dependencies available in dependency data store 113. Each application environment 108 may have different dependencies available to the servers and application instances within the respective application environment. For example, application instances 118 running on servers 110 within application environment 108A may have access to certain test data or data scenarios stored in data store 112 that may be different than the test data or data scenarios stored in data store 113 accessible by application instances 120 running on servers 111 within application environment 108B. Although illustrated herein as though all dependencies for a given application environment are included in a single data store, the external dependencies accessible by servers and applications running within a given application environment may be stored across multiple data stores and/or databases.

During execution, applications and application services may make service calls to other applications via API gateway 107. API gateway 107 is an API software management tool that sits between a client, e.g., user devices, and backend services, e.g., application instances 118, 120. API gateway 107 receives a service call for a target application, transmits the service call to an instance of the target application, and returns the result to a source client or instance of a source application. In other words, API gateway 107 maps an application front-end to a particular backend application environment to facilitate requests and delivery of data and services. In networks including multiple application environments, as illustrated in FIG. 1, API gateway 107 is hard coded to map service calls to an instance of the target application in a certain target environment.

Developers may interact with one or more of application environments 108 via user devices 116 when developing, testing, staging, and/or deploying applications. User devices 116 may be workstations or other computing devices that the software developers use to write, compile and execute code representative of applications for testing and/or deployment. As an example, developers, via user devices 116, may create various data scenarios intended to test an application and may store the various data scenarios in dependency data store 112 accessible by a first application environment 108A. When the application is tested in the first application environment 108A, the application may make service calls to instances of other applications or application services hosted on servers in different application environments, e.g., application environment 108B, that do not have access to the same data as the first application environment, i.e., dependency data store 112 of first application environment 108A. The data mismatch between environments 108A, 108B may result in inaccurate, stalled, or failed tests, which can delay further development and deployment of applications.

As an example, an instance 118A of an application under test in application environment 108A may make a service call to a target application via API gateway 107. API gateway 107 is hard coded to map the service call to an instance of the target application in a certain target environment, e.g., application environment 108B, which has access to dependency data store 113, which includes different databases and other external dependencies than dependency data store 112 of application environment 108A. Conventionally, a change to the hard coded target environment for the target application is pushed to the API gateway as a static endpoint string that is manually created by a developer, approved by a second developer, submitted to the build process by the developer, and then submitted to the deployment process by the developer. Thus, changes to the hard coded mapping of the API gateway conventionally takes days if not weeks to occur.

One potential solution is to maintain duplicate dependencies across all application environments 108, but that approach may be resource prohibitive. Data included in the various data scenarios for testing is dynamic, which makes it difficult to keep data consistently replicated across multiple application environments. In addition, it may be undesirable or even impossible to store duplicate data sets across multiple application environments due to storage constraints.

In accordance with techniques of this disclosure, environment selection agent 122 provides a user interface by which a user, e.g., a developer or administrator, via one of user devices 116 may select a target application environment for a particular target application. Environment selection agent 122 may generate data representative of a user interface for presentation to the user via the associated one of user devices 116. The user interface may include one or more interactive components, e.g., a fillable field, drop-down menu, radio buttons, or the like, to enable the user to select the preferred target environment for the target application via the one of user devices 116. In response to receipt of the selection of the target environment via the user interface, environment selection agent 122 automatically generates an endpoint string for service calls for the target application that indicates a route to an instance of the target application executing in the selected target environment. Environment selection agent 122 then sends a message including the endpoint string to API gateway 107 to instruct API gateway 107 to modify an environment mapping for the target application in accordance with the endpoint string. Once the environment mapping is updated, API gateway 107 sends service calls for the target application to the instance of the target application executing in the target environment in accordance with the environment mapping for the target application.

The techniques of this disclosure provide one or more technical advantages and practical applications. For example, the disclosed techniques enable developer-selected, on-demand modifications to environment mappings at API gateway 107 without the long lead time required for manual modification. In addition, the disclosed techniques ensure that applications under test have access to the same data scenarios without needing to maintain duplicate data dependencies. Environment selection agent 122 provides an automated solution for generation of endpoint strings used to update an environment mapping of API gateway 107 in real-time. This tool may be especially useful for software developers that may want to point service calls of an application under test to multiple test environments to access specific data that is accessible within the different environments or for different types of testing. Moreover, developers may also use the disclosed tool to point service calls of an application under test to different test environments during different stages of the software development process. Developers may further use the disclosed tool to point service calls of an application under test to different test environments if a preferred or typical test environment is temporarily down and a short-term environment for testing is needed. Additionally, developers may use the disclosed tool to point service calls of an application under test to a production environment, instead of a test environment, to debug production issues prior to deployment of the application.

In some examples, environment selection agent 122 may configure the target environment of an application on a per-microservice and/or a per-environment basis. For example, environment selection agent 122 may generate a source environment specific endpoint string that defines the target environment for service calls for a particular application or application service that originate from applications executing in a first environment. In this way, the disclosed techniques may avoid data mismatch concerns when developing and testing software applications in a particular environment, e.g., the first environment.

As an example, a development team may create various data scenarios intended to test an application and may store the various data scenarios in dependency data store 112 accessible by application environment 108A. When the application is tested in application environment 108A, environment selection agent 122 may receive selections of application environment 108A for the other applications or application services to which the application-under-test makes service calls to ensure all of the applications have access to the same data scenarios stored in dependency data store 112. In response to the selection of application environment 108A for a particular target application, environment selection agent 122 generates an endpoint string for service calls for the particular target application that indicates a route to an instance 118 of the target application executing in target application environment 108A. The endpoint string may specify an address of the instance of the particular target application executing in the target environment. Environment selection agent 122 sends a message including the endpoint string to API gateway 107 that instructions API gateway 107 to modify an environment mapping for the particular target application in accordance with the endpoint string. The modified environment mapping causes API gateway 107 to send subsequent service calls for the particular target application to the instance 118 of the target application executing in application environment 108A. In this way, the disclosed techniques ensure that the application-under-test and the associated applications have access to the same data scenarios accessible by application environment 108A.

Environment selection agent 122 may further generate data representative of a dashboard user interface for display via user devices 116 configured to indicate a current target environment mapping of each application of a plurality of applications in software development system 100. The dashboard user interface may include indications of all or a subset of the plurality of applications and the application environments in which instances of the applications are executing. The dashboard user interface may include a table of environment mappings for the plurality of applications. The table of environment mappings may include an entry for each application of the plurality of applications that indicates the currently selected application environment as a target environment for the respective application. In addition, the dashboard user interface may include a table of service calls made by source or sender application instances, e.g., applications-under-test, executing in a source or sender environment to one or more target applications and the corresponding target environments in which instances of the target applications are executing. For example, the dashboard user interface may display that application instance 118A is executing or being tested in application environment 108A. In addition, the dashboard user interface may display that application instance 118A made a service call to application instance 120A in application environment 108B. In some scenarios, the dashboard user interface may further include, for each application, an indication that testing is in progress using the respective application.

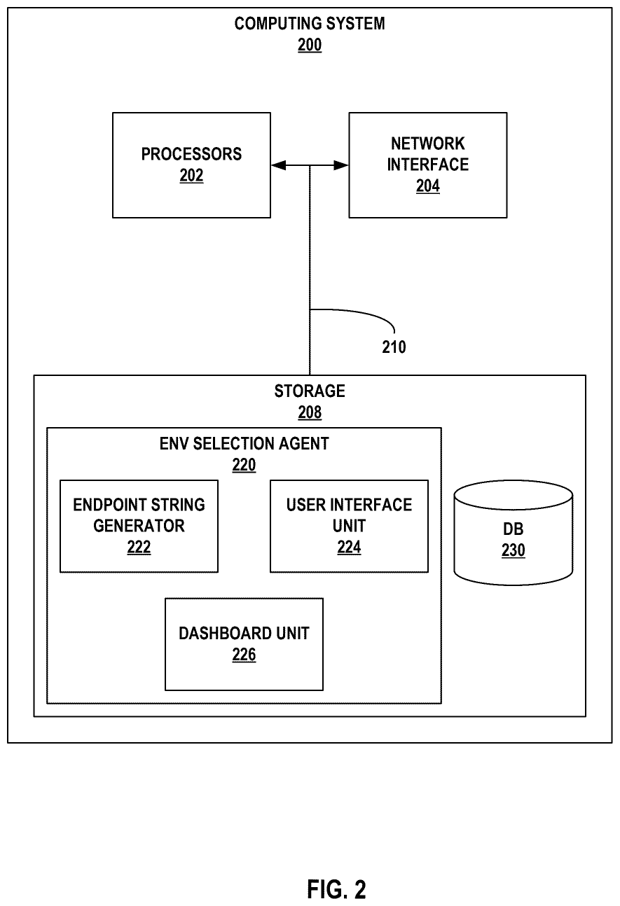

FIG. 2 is a block diagram illustrating a computing system 200 including an environment selection agent 220, in accordance with one or more aspects of the present disclosure. Computing system 200 of FIG. 2 is illustrated as a block diagram with specific components and data modules. In examples described in connection with FIG. 2, computing system 200 may correspond to, or may be considered an example or alternative implementation of, computing system 106 of FIG. 1. For ease of illustration, computing system 200 is illustrated in FIG. 2 as a single computing system. However, in other examples, computing system 200 may comprise multiple devices or systems, such as systems distributed across a data center or multiple data centers. For example, a separate computing system may implement functionality performed by the environment selection agent 220, as described below. Alternatively, or in addition, computing system 200 (or various modules illustrated in FIG. 2 as included within computing system 200) may be implemented through distributed virtualized compute instances (e.g., virtual machines, containers) of a data center, cloud computing system, server farm, and/or server cluster.

In FIG. 2, computing system 200 is illustrated as including processors 202, network interface 204, and storage 208. Storage 208 may include various modules or otherwise-implemented logic for performing various functions described herein. Such modules may include endpoint string generator 222, user interface unit 224, and dashboard unit 226 of environment selection agent 220. Environment selection agent 220 may correspond to environment selection agent 122 of FIG. 1. Storage 208 may also include a database 230 that may store previously created endpoint strings associated with different application environments of the enterprise network, e.g., application environments 108 from FIG. 1. One or more of the devices, modules, storage areas, or other components of computing system 200 may be interconnected to enable inter-component communications (physically, communicatively, and/or operatively). In some examples, such connectivity may be provided by through communication channels, which may include a system bus, a network connection, an inter-process communication data structure, or any other method for communicating data.

Processors 202 may include one or more processors such as a virtualized processor, multi-core processor, or other type of processor. Processors 202 may provide an execution environment for computing system 200 and may implement functionality and/or execute instructions stored in storage 208. Processors 202 may be, may be part of, and/or may include processing circuitry that performs operations in accordance with one or more aspects of the present disclosure. For example, processors 202 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Network interface 204 of computing system 200 may facilitate the exchange of data and communication with other devices or systems via one or more networks by transmitting and/or receiving network signals on the one or more networks. Examples of network interfaces 204 include a network interface card (e.g., such as an Ethernet card), an optical transceiver, a radio frequency transceiver, or any other type of device that can send and/or receive information, such as through a wired or wireless network. Other examples of interfaces 204 may include short wave radios, cellular data radios, wireless Ethernet network radios, as well as universal serial bus (USB) controllers.

In some examples, interfaces 204 of computing system 200 may operate as input and/or output devices. Examples of input are tactile, audio, and video input. Examples of interfaces 204 configured to receive input include a presence-sensitive screen, touch-sensitive screen, mouse, keyboard, voice responsive system, video camera, microphone, or any other type of device for detecting input from a human or machine. Examples of output are tactile, audio, and video output. Examples of interfaces 204 configured to generate output include a presence-sensitive screen, sound card, video graphics adapter card, speaker, cathode ray tube (CRT) monitor, liquid crystal display (LCD), or any other type of device for generating output to a human or machine.

Storage 208 may store information for processing during operation of computing system 200. In some examples, storage 208 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. In some cases, storage 208 may include redundant array of independent disks (RAID) configurations and one or more solid-state drives (SSDs).

Storage 208, in some examples, also include one or more computer-readable storage media. Storage 208 may be configured to store larger amounts of information than volatile memory. Storage 208 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories.

Storage 208 may store program instructions and/or data associated with one or more of the modules described in accordance with one or more aspects of this disclosure. In the illustrated example of FIG. 2, storage 208 may store instructions and/or data associated with endpoint string generator 222, user interface unit 224, and dashboard unit 226 of environment selection agent 220. Processors 202 and Storage 208 may provide an operating environment or platform for such modules, which may be implemented as software, but may in some examples include any combination of hardware, firmware, and software. Processors 202 may execute instructions and storage 208 may store instructions and/or data of one or more modules. The combination of processors 202 and storage 208 may retrieve, store, and/or execute the instructions and/or data of one or more applications, modules, or software. Processors 202 and/or storage 208 may also be operably coupled to one or more other software and/or hardware components, including, but not limited to, one or more of the components of computing system 200 and/or one or more devices or systems illustrated or described as being connected to computing system 200.

As noted above, environment selection agent 220 may correspond to environment selection agent 108 of FIG. 1. Processors 202 may execute environment selection agent 220 and network interface 204 may facilitate communication between environment selection agent and an API gateway, e.g., API gateway 107 from FIG. 1. Environment selection agent 220 operates as a logical switch for the API gateway 107 and enables a user, e.g., a developer or an administrator, to select a preferred target environment from among two or more target environments in which an application or application service is executing to send service calls for the application or application service. In the illustrated example of FIG. 2, environment selection agent 224 includes endpoint string generator 222, user interface unit 224, and dashboard unit 226.

User interface unit 224 may generate data representative of a user interface for display via a user device, such as user devices 116 from FIG. 1. For example, computing system 200 may send or make accessible the data representative of the user interface via network interface 204. The generated user interface may include one or more interactive components, e.g., a fillable field, drop-down menu, radio buttons, or the like, to enable a developer, administrator, or other user to select a preferred target environment for a particular target application or application service. In some examples, the user interface generated by user interface unit 224 may include a list of applications or application services from which the user may select the particular target application. In some cases, the user interface may list all available applications by name or another assigned identifier. In other cases, the user interface may order the list of application by the most frequently used or “top” applications.

For the selected or otherwise identified target application, the user interface generated by user interface unit 224 may create a list of application environments that are currently executing instances of the target application from which the user may select the preferred target environment for the particular target application. For example, the user interface may include a drop-down menu that includes two application environments of four application environments included in the enterprise network, where instances of the particular target application are only running in the two application environments. User interface unit 224 may receive user input data that is representative of the selection of the target environment for the particular target application or application service from one of the user devices, e.g., one of user devices 116 from FIG. 1, via network interface 204. User interface unit 224 may send data that represents the selected target environment to endpoint string generator 222.

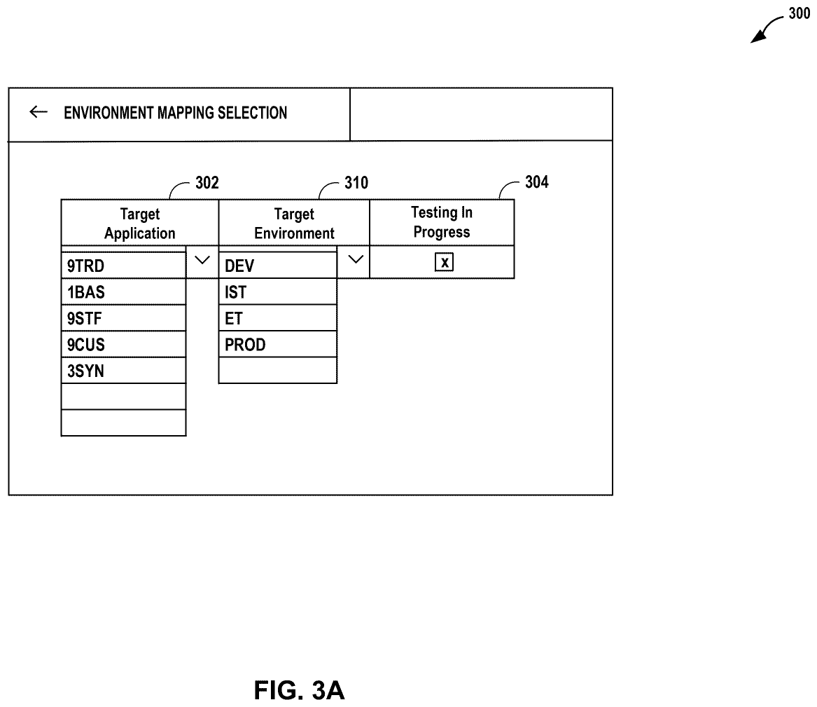

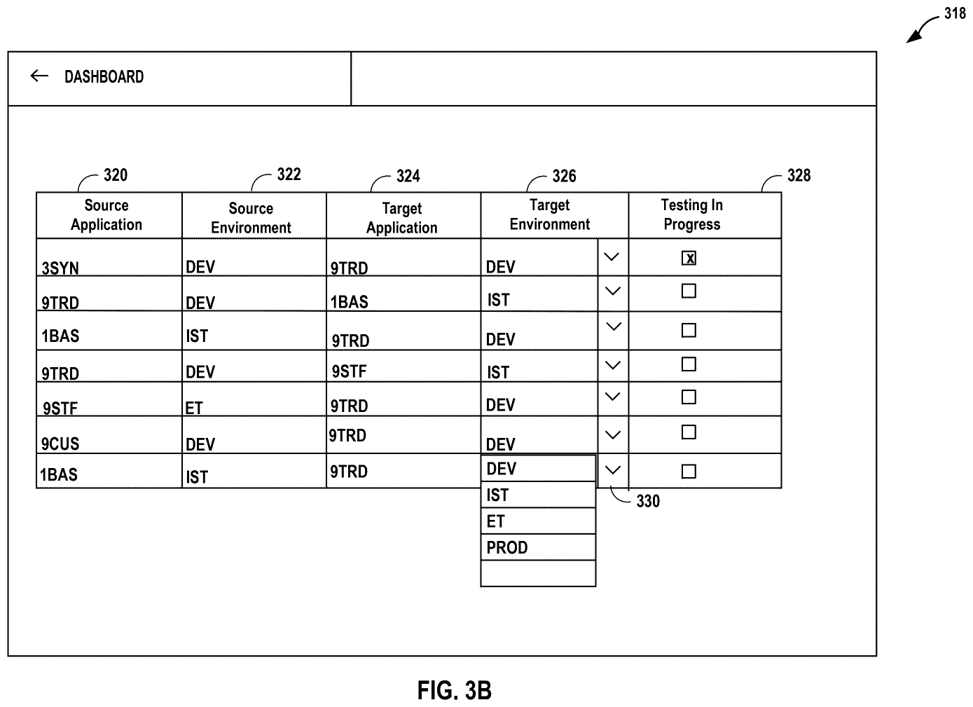

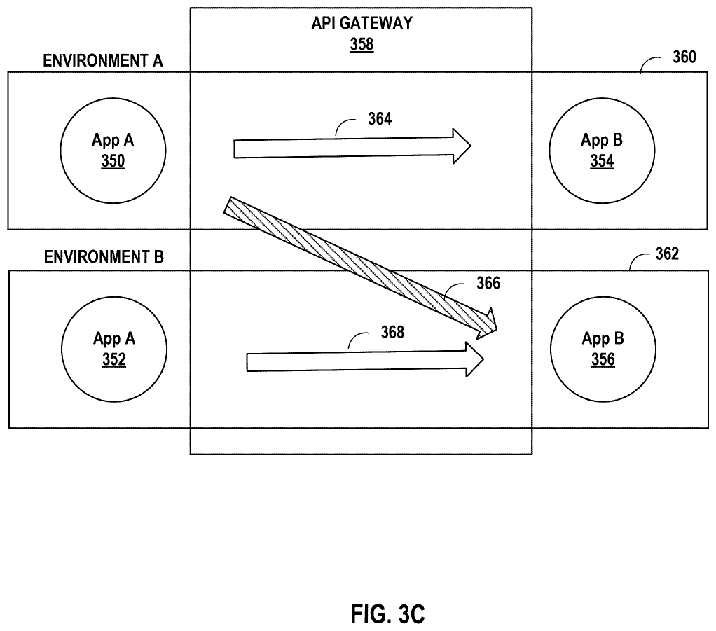

In some examples, user interface unit 224 may generate the user interface to include an indication of whether the particular target application is currently being used for testing of another application under test and/or by another developer. Upon receipt of the selection of the particular target application, user interface unit 224 may automatically generate an indicator to indicate whether the particular target application is currently in use. In some scenarios, when the particular target application is in use, user interface unit 224 may disable selection of a different target environment for the particular target application. In some examples, user interface unit 224 may further include a manual push button associated with the particular target application for the developer to indicate that the particular target application is in use or that testing is in progress using the particular target application in a selected application environment. An example of the user interface is described in more detail with respect to FIG. 3A.

Endpoint string generator 222 may be configured to automatically generate endpoint strings that indicate routes to application instances of target applications executing in particular application environments. For example, based on receipt of the data that represents the selected target application and selected target environment from user interface unit 224, endpoint string generator 222 may automatically generate an endpoint string that indicates a route to an instance of the selected target application executing in the selected target environment. For example, the generated endpoint string may specify an address of the instance of the selected target application executing in the selected target environment. Endpoint string generator 222 may further be configured to send messages including the generated endpoint strings to an API gateway, e.g., API gateway 107 from FIG. 1, via network interface 204. The messages may instruct the API gateway to modify an environment mapping for the particular target application in accordance with the generated endpoint string to cause the API gateway to send service calls for the target application to the instance of the target application executing in the target environment.

In accordance with one or more techniques of this disclosure, endpoint string generator 222 may automatically generate an endpoint string by either retrieving a previously created endpoint string from database 230 or creating an endpoint string “on-demand.” In one example, endpoint string generator 222 may generate an endpoint string for service calls for the target application by retrieving a previously created endpoint string associated with the selected target environment from database 230. Database 230 may store a set of previously created endpoint strings where each endpoint string is associated with one of the available application execution environments of the enterprise network, e.g., in enterprise networks having four environments, database 230 may store four previously created endpoint strings with one for each environment. Endpoint string generator 222 may modify the previously created endpoint string associated with the target environment as necessary based on the data received from user interface unit 224 to appropriately indicate the route to the instance of the target application executing in the target environment.

In another example, if there is no previously created endpoint string associated with the target environment available in database 230 or if user interface unit 224 receives selection of a new target environment from a developer via a fillable field, endpoint string generator 222 may create the endpoint string “on-demand” in response to receipt of the selection of the target environment for the target application. In this example, the newly created endpoint string may be subject to an approval and deployment process. Endpoint string generator 222 may store generated endpoint strings to database 230.

Dashboard unit 226 may generate data representative of a dashboard user interface for display via a user device, such as user devices 116 from FIG. 1. For example, computing system 200 may send or make accessible the data representative of the dashboard via network interface 204. In some examples, the generated dashboard may present data in a read-only table or other structure to at least indicate a current target environment mapping of each application of a plurality of applications. In other examples, the generated dashboard may comprise an interactive dashboard user interface that presents the current target environment mapping of each application of the plurality of applications and further includes one or more interactive components, e.g., a fillable field, drop-down menu, radio buttons, or the like, to receive a user selection of a new target environment for a particular target application or application service.

The dashboard generated by dashboard user 226 may include indications of all or a subset of the plurality of applications and the application environments in which instances of the applications are executing. The dashboard user interface may include a table of environment mappings for the plurality of applications. The table of environment mappings may include an entry for each application of the plurality of applications that indicates the currently selected application environment as a target environment for the respective application. In addition, the dashboard user interface may include a table of service calls made by source application instances, e.g., applications-under-test, executing in a source environment to one or more target applications and the corresponding target environments in which instances of the target applications are executing. In some scenarios, the dashboard user interface may further include, for each application, an indication that testing is in progress using the respective application. An example of an interactive dashboard user interface is described in more detail with respect to FIG. 3B.

FIG. 3A is a conceptual diagram illustrating an example user interface 300 configured to allow users to select a target application and a corresponding target execution environment for the target application, in accordance with one or more techniques of this disclosure. User interface 300 includes Environment mapping selection user interface 300 may be generated by an environment selection agent, such as environment selection agent 122 from FIG. 1 or environment selection agent 220 from FIG. 2, for display via a user device, e.g., one of user devices 116 of FIG. 1, to a developer or other user.

As illustrated in FIG. 3A, environment mapping selection user interface 300 includes a first interactive component 302, i.e., a drop-down menu, with which a user may select a particular target application. For example, a target application may be an application to which an application-under-test makes one or more service calls during execution. In the example where the first interactive component comprises a drop-down menu, the options for selection may include all available applications executing within an enterprise network or a reduced set of “top” or most commonly used applications. FIG. 3A illustrates five different target applications included in the drop-down menu. In other examples, the number of available applications may be in the hundreds or thousands. Although illustrated in FIG. 3A as a drop-down menu, in other examples, first interactive component 302 may comprise a fillable field, radio buttons, or the like.

Environment mapping selection user interface 300 also includes a second interactive component 310, i.e., a drop-down menu, with which the user may select a particular target application environment corresponding to the particular target application selected in first interactive component 302. For example, a target application environment may be an execution environment that hosts an instance of the particular target application. In the example where the second interactive component comprises a drop-down menu, the options for selection may include all available environments currently hosting or executing instances of the particular target application. FIG. 3A illustrates four different target applications included in the drop-down menu, i.e., a development environment (DEV), two test environments (IST and ET), and a production environment (PROD). In other examples, there may be more or fewer available test environments. Although illustrated in FIG. 3A as a drop-down menu, in other examples, second interactive component 310 may comprise a fillable field, radio buttons, or the like.

Environment mapping selection user interface 300 also includes a “testing in progress” flag 304 associated with the particular target application selected in first interactive component 302. Upon selection of the particular target application in first interactive component 302, environment mapping selection user interface 300 may automatically populate flag 304 to indicate whether the particular target application is currently in use by another application under test. In the example where the flag 304 is set, environment mapping selection user interface 300 may disable selection of a different target environment to avoid modification of the environment mapping for the particular target application at the API gateway while the target application is in use. In some scenarios, the “testing in progress” flag 304 may comprise a third interactive component, e.g., a radio button, with which the user can indicate that the particular target application is in use or that testing is in progress using the particular target application by the developer in order to prevent other developers from modifying the target environment during testing.

In some examples, the selection of a new target environment for the target application may comprise an “on-demand” edit to the environment mapping of service calls for the target application to an instance of the target application executing in the new target environment at the API gateway. The target environment selection functionality, e.g., environment selection agent 122 or 220, automatically generates an endpoint string for the service calls for the target application that indicates a route to the instance of the target application executing in the new target environment. The environment selection functionality then sends a message to the API gateway that includes the endpoint string and instructs the API gateway to modify the target environment of the target application in accordance with the route in the endpoint string. In this way, the environment selection functionality automatically updates the endpoint string and instructs the API gateway to change how the subsequent service calls for the target application are routed.

FIG. 3B is a conceptual diagram illustrating an example interactive dashboard 318 configured to allow users to select a target application and a corresponding target execution environment for the target application, in accordance with one or more techniques of the present disclosure. Interactive dashboard 318 may be generated by an environment selection agent, such as environment selection agent 122 from FIG. 1 or environment selection agent 220 from FIG. 2, for display via a user device, e.g., one of user devices 116 of FIG. 1, to a developer or other user.

As illustrated in FIG. 3B, interactive dashboard 318 displays a table of service calls made by source application instances, e.g., applications-under-test, executing in a source environment to one or more target applications and the corresponding target environments in which instances of the target applications are executing. More specifically, interactive dashboard 318 includes a first component 320 that displays a list of source applications that each initiated a service call and a second component 322 that displays a list of source environments in which instances of the corresponding source applications were executing when the service call was initiated. Interactive dashboard 318 also includes a third component 324 that displays a list of target applications that are destinations of the service calls initiated by the corresponding source applications in component 320. Interactive dashboard 318 further includes a fourth component 326 that displays a list of current target environments to which the service calls for the corresponding target applications are mapped.

In the example of FIG. 3B, each entry of fourth component 326 comprises an interactive component 330, i.e., a drop-down menu, with which the user may select a new target application environment for the corresponding target application in component 324 that is the destination of the service call initiated by the corresponding source application in component 320. For example, in the bottom entry of the table shown in interactive dashboard 318, a source application 1BAS executing in source environment IST makes a service call to target application 9TRD, which is currently mapped to target environment DEV by the API gateway. Interactive component 330 of component 326 allows the user to select one of the other application environments in which an instance of the target application 9TRD is executing. FIG. 3B illustrates four different target applications environments included in the drop-down menu, i.e., a development environment (DEV), two test environments (IST and ET), and a production environment (PROD). In other examples, there may be more or fewer available test environments. Although illustrated in FIG. 3B as a drop-down menu, in other examples, interactive component 330 may comprise a fillable field, radio buttons, or the like.

Interactive dashboard 318 also includes a “testing in progress” flag 328 associated with the particular target application in third component 324. Upon creation of an entry in the table of interactive dashboard 318 in response to a service call for the particular target application, interactive dashboard 318 may automatically populate flag 328 to indicate whether the particular target application is currently in use by another application under test. In the example where the flag 328 is set, dashboard 318 may disable selection of a different target environment via interactive component 330 to avoid modification of the environment mapping for the particular target application at the API gateway while the target application is in use. In some scenarios, the “testing in progress” flag 328 may comprise another interactive component, e.g., a radio button, with which the user can indicate that the particular target application is in use or that testing is in progress using the particular target application by the developer in order to prevent other developers from modifying the target environment during testing.

FIG. 3C is a conceptual diagram illustrating an example environment mapping modification at an API gateway 358, in accordance with one or more techniques of this disclosure. In some examples, API gateway 358 may correspond to, or may be considered an example or alternative implementation of, API gateway 358 of FIG. 1.

In one example, a network includes a first application environment A 360 running an instance 350 of Application A and an instance 354 of Application B. Network 300 also includes a second application environment B 362 running an instance 352 of Application A and an instance 356 of Application B. API gateway 358 may receive a service call from instance 350 of Application A in environment A 350 for Application B. API gateway 358 may be currently configured to send the service call for Application B along a route 366 to instance 356 of Application B in environment B 362.

In order to change the target environment for Application B, a developer of Application A may access an environment selection agent, e.g., environment selection agent 122 from FIG. 1 or environment selection agent 220 from FIG. 2, and select environment A 360 as the preferred target environment for Application B. As described above, the environment selection agent generates an endpoint string for service calls for Application B that indicates a route 364 to instance 354 of Application B executing in environment A 360. The environment selection agent sends a message including the endpoint string to API gateway 358. In response to the message, API gateway 358 modifies the environment mapping for Application B in accordance with the endpoint string. In this way, API gateway 358 is instructed to rewrite or replace the route associated with service calls for Application B, e.g., removing route 366 and adding route 364. The modified environment mapping causes API gateway 358 to send subsequent service calls for Application B along route 364 to instance 354 of Application B executing in environment A 360.

In some examples, the modified environment mapping described above may be source environment agnostic, meaning that service calls for Application B originating from application instances executing in any application environment, e.g., environment A 360 or environment B 362, will be routed to an instance of Application B executing in environment A 360. In other examples, the modified environment mapping described above may be source environment specific, meaning that the modified mapping only applies to service calls for Application B originating from application instances executing in environment A 360.

As an example of a source environment specific mapping in FIG. 3C, API gateway 358 may modify a first entry in a table of environment mappings to map service calls for Application B that originate from application instances executing in environment A 360 to be routed along route 364 to instance 354 of Application B executing in environment A 360. API gateway 358, however, may also maintain a second entry in the table of environment mappings that maps service calls for Application B that originate from application instances executing in environment B 362 to be routed along route 368 to instance 356 of Application B executing in environment B 362. In this way, the table of environment mappings causes API gateway 358 to send service calls for Application B originating from environment A 360 along route 364 to instance 354 of Application B executing in environment A 360, and send service calls for Application B originating from environment B 362 along route 368 to instance 356 of Application B executing in environment B 362.

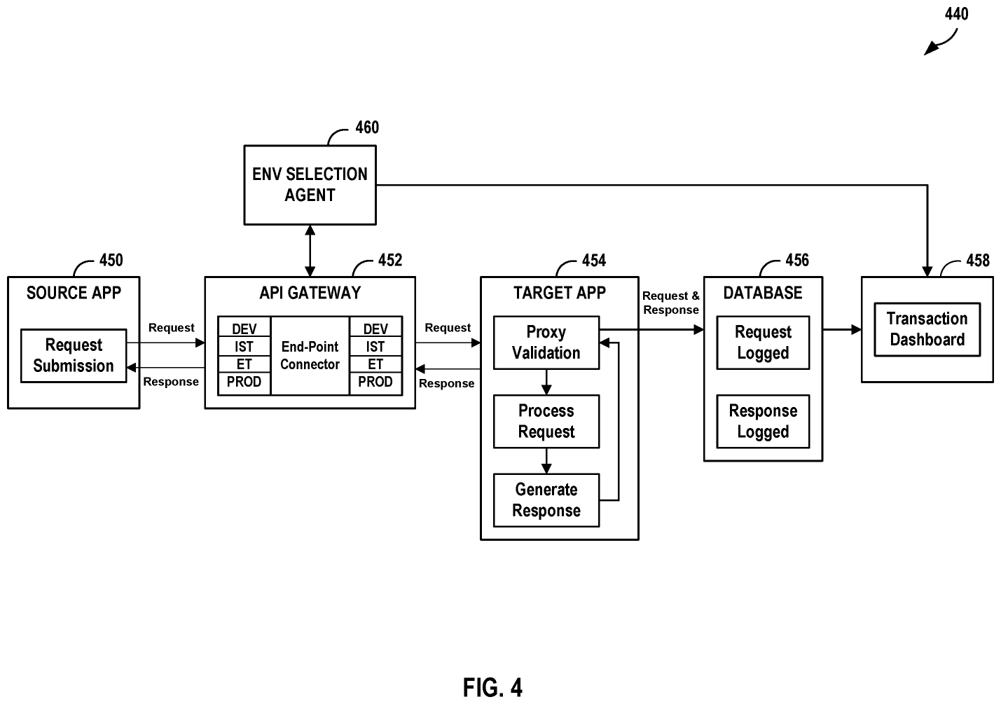

FIG. 4 is a block diagram illustrating an example operation of an environment selection agent 460 in a software development system 440, in accordance with one or more techniques of this disclosure. Software development system 440 illustrated FIG. 4 includes a source application 450, API gateway 452, a target application 454, a service call database 456, a transaction dashboard 458, and environment selection agent 460. In some examples, software development system 44 may correspond to, or may be considered an example or alternative implementation of, software development system 100 of FIG. 1. API gateway 452 may operate substantially similar to API gateway 107 from FIG. 1 and/or API gateway 358 from FIG. 3C. Environment selection agent 460 may operate substantially similar to environment selection agent 122 from FIG. 1 and/or environment selection agent 220 from FIG. 2.

In accordance with one or more techniques of this disclosure, source application 450 submits service request to target application 454 via API gateway 452, and target application 454 processes the service request, generate a service response, and returns the service response to source application 450 via API gateway 452. As illustrated in FIG. 4, API gateway 452 includes an endpoint connector in an environment mapping to route the service request and service response between execution environments, e.g., DEV, IST, ET, or PROD. The service request and service response between source application 450 and target application 454 may be logged at service call database 456. In some examples, transaction dashboard 458 may be generated based, at least in part, on the service requests and responses logged in database 456.

In accordance with the disclosed techniques, environment selection agent 460 generates data representative of a user interface configured to receive a selection of a new target environment for target application 454. In response to receipt of the selection of the new target environment for target application 454, environment selection agent 460 automatically generates an endpoint string for service calls for target application 454 that indicates a route to an instance of target application 454 executing in the new target environment. Environment selection agent 460 sends a message to API gateway 452. The message includes the endpoint string and instructs API gateway 452 to modify the current endpoint connector in the environment mapping in accordance with the endpoint string to route the service request for target application 454 to the new target environment. Once the endpoint connector in the environment mapping is modified, API gateway 452 send service calls for target application 454 to the instance of target application 454 executing in the new target environment.

In response to target application 454 receiving the service request from source application 450 via API gateway 452, a proxy validation process may be initiated to verify the permission of the service request for target application 454. The proxy validation process may ensure that service requests passing through the proxy of target application 454 are valid and meet certain criteria before being processed by target application 454. In response to the service request being validated, target application 454 may process and generate the service response to source application 450 via API gateway 452. The service request (upon validation) and the service response are logged at service call database 456.

Environment selection agent 460 may further generate data representative of transaction dashboard 458 based, at least in part, on the service requests and responses logged in database 456. Transaction dashboard 458 may include indications of all or a subset of the plurality of applications and the application environments in which instances of the applications are executing. Transaction dashboard 458 may display a table of environment mappings for the plurality of applications. In addition, transaction dashboard 458 may display a table of service calls made by source applications executing in a source environment to one or more target applications and the corresponding target environments in which instances of the target applications are executing.

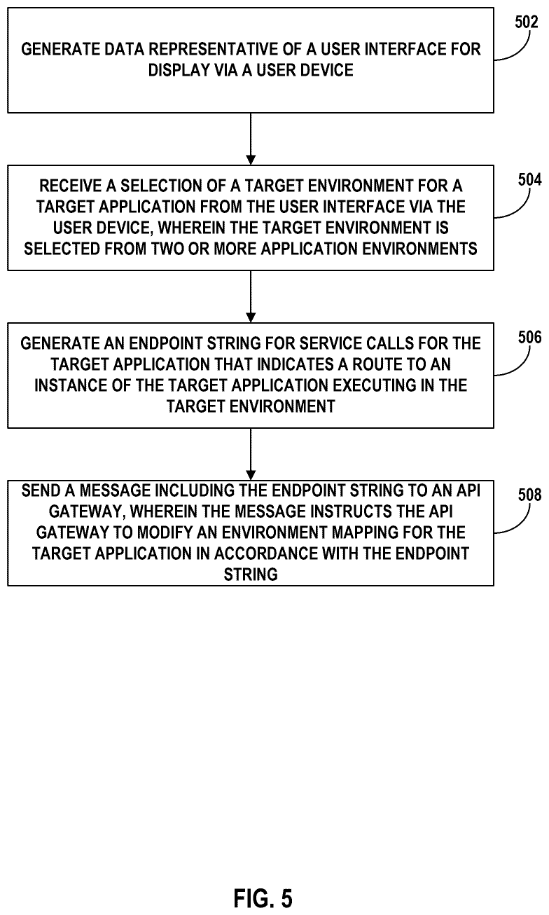

FIG. 5 is a flowchart illustrating operations performed by an example computing system, in accordance with one or more techniques of this disclosure. The operations of FIG. 5 a redescribed below with respect to computing system 200 of FIG. 2. In other examples, the operations described in FIG. 5 may be performed by one or more other components, modules, systems, or devices. Further, in other examples, operations described in connection with FIG. 5 may be merged, performed in a difference sequence, omitted, or may encompass additional operations not specifically illustrated or described.

Computing system 200 generates data representative of a user interface for display via a user device (502). For example, user interface unit 224 of environment selection agent 220 of computing system 200 may generate data representative of a user interface for display via one of user devices 116 of FIG. 1. In some examples, the user interface includes interactive components from which to receive one or more inputs from a user of the user device, wherein the one or more inputs are indicative of the selection of the target environment for the target application.

Computing system 200, may receive a selection of a target environment for a target application from the user interface via the user device, wherein the target environment is selected from two or more application environments (504). For example, user interface unit 224 of environment selection agent 220 of computing system 200 may receive user input data that is representative of the selection of the target environment for the particular target application or application service from the one of user devices 116 via network interface 204. In some examples, the target environment comprises an execution environment for a plurality of application instances, including the instance of the target application. The target application may comprise a destination of a service call from an instance of a source application executing in a source environment of the two or more application environments. In some examples, the source environment and the target environment may be the same execution environment. In other examples, the source environment and the target environment may be different execution environments.

Computing system 200 generates an endpoint string for service calls for the target application that indicates a route to an instance of the target application executing in the target environment (506). For example, endpoint string generator 222 may generate an endpoint string that indicates a route to the instance of the target application executing in the selected target environment based on data of the selection received from user interface unit 224. The endpoint string may specify an address of the instance of the target application executing in the target environment. In some examples, endpoint string generator 222 creates the endpoint string in response to receipt of the selection of the target environment for the target application. In another example, endpoint string generator 222 retrieving the endpoint string from database 230 of previously created endpoint strings in response to receipt of the selection of the target environment for the target application.

Computing system 200 sends a message including the endpoint string to an API gateway that instructs the API gateway to modify an environment mapping for the target application in accordance with the endpoint string (508). For example, endpoint string generator 222 of environment selection agent 220 of computing system 200 may send messages including the generated endpoint strings to an API gateway, e.g., API gateway 107 from FIG. 1, via network interface 204.

In some examples, the message including the endpoint string instructs the API gateway to modify the environment mapping for the target application to map service calls for the target application that originate from application instances executing in a particular application environment of the two or more application environments to be routed to the instance of the target application executing in the target environment in accordance with the endpoint string. In another example, the message including the endpoint string instructs the API gateway to modify the environment mapping for the target application to map service calls for the target application that originate from application instances executing in any application environment of the two or more application environments to be routed to the instance of the target application executing in the target environment in accordance with the endpoint string.

Computing device 200 may further generate data representative of a dashboard user interface that includes a table of environment mappings for a plurality of applications for display via the user device, wherein the table of environment mappings includes an entry for each application of the plurality of applications that indicates a currently selected application environment of the two or more application environments as a target environment for the respective application. In some examples, the dashboard user interface may comprise an interactive dashboard in which each entry in the table of environment mappings includes a user interface from which to receive a selection of the target environment for the respective application via the user device. For example, dashboard unit 226 of environment selection agent 220 of computing system 200 may generate data representative of the dashboard user interface for display via one of user devices 116 of FIG. 1.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each depict at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the illustrations and/or may include additional devices and/or components not shown in the illustrations.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

What is claimed is:

1. A method, comprising:
generating, by a computing system, data representative of a user interface for display via a user device;
receiving, by the computing system, a selection of a target environment for a target application from the user interface via the user device, wherein the target environment is selected from two or more application environments;
generating, by the computing system, an endpoint string for service calls for the target application that indicates a route to an instance of the target application executing in the target environment; and
sending, by the computing system, a message including the endpoint string to an application programming interface (API) gateway, wherein the message instructs the API gateway to modify an environment mapping for the target application in accordance with the endpoint string such that the environment mapping causes the API gateway to send the service calls for the target application to the instance of the target application executing in the target environment.

2. The method of claim 1, wherein the user interface includes interactive components from which to receive one or more inputs from a user of the user device, wherein the one or more inputs are indicative of the selection of the target environment for the target application.

3. The method of claim 1, wherein the target environment comprises an execution environment for a plurality of application instances, wherein the plurality of application instances executing in the target environment includes the instance of the target application.

4. The method of claim 1, wherein the target application is a destination of a service call from an instance of a source application executing in a source environment of the two or more application environments.

5. The method of claim 4, wherein the source environment is a same application environment as the target environment.

6. The method of claim 1, wherein the endpoint string specifies an address of the instance of the target application executing in the target environment.

7. The method of claim 1, wherein generating the endpoint string comprises creating the endpoint string in response to receipt of the selection of the target environment for the target application.

8. The method of claim 1, wherein generating the endpoint string comprises retrieving the endpoint string from a database of previously created endpoint strings in response to receipt of the selection of the target environment for the target application.

9. The method of claim 1, wherein the message including the endpoint string instructs the API gateway to modify the environment mapping for the target application to map service calls for the target application that originate from application instances executing in a particular application environment of the two or more application environments to be routed to the instance of the target application executing in the target environment in accordance with the endpoint string.

10. The method of claim 1, wherein the message including the endpoint string instructs the API gateway to modify the environment mapping for the target application to map service calls for the target application that originate from application instances executing in any application environment of the two or more application environments to be routed to the instance of the target application executing in the target environment in accordance with the endpoint string.

11. The method of claim 1, further comprising generating data representative of a dashboard user interface that includes a table of environment mappings for a plurality of applications for display via the user device, wherein the table of environment mappings includes an entry for each application of the plurality of applications that indicates a currently selected application environment of the two or more application environments as a target environment for the respective application.

12. The method of claim 11, wherein each entry in the table of environment mappings includes a user interface from which to receive a selection of the target environment for the respective application via the user device.

13. A computing system comprising:
memory; and
processing circuitry in communication with the memory, the processing circuitry configured to:
generate data representative of a user interface for display via a user device;
receive a selection of a target environment for a target application from the user interface via the user device, wherein the target environment is selected from two or more application environments;
generate an endpoint string for service calls for the target application that indicates a route to an instance of the target application executing in the target environment; and
send a message including the endpoint string to an application programming interface (API) gateway, wherein the message instructs the API gateway to modify an environment mapping for the target application in accordance with the endpoint string such that the environment mapping causes the API gateway to send the service calls for the target application to the instance of the target application executing in the target environment.

14. The computing system of claim 13, wherein the user interface includes interactive components from which to receive one or more inputs from a user of the user device, wherein the one or more inputs are indicative of the selection of the target environment for the target application.

15. The computing system of claim 13, wherein the endpoint string specifies an address of the instance of the target application executing in the target environment.

16. The computing system of claim 13, wherein to generate the endpoint string, the processing circuitry is configured to retrieve the endpoint string from a database of previously created endpoint strings in response to receipt of the selection of the target environment for the target application.

17. The computing system of claim 13, wherein to generate the endpoint string, the processing circuitry is configured to create the endpoint string in response to receipt of the selection of the target environment for the target application.

18. The computing system of claim 13, wherein the message including the endpoint string instructs the API gateway to modify the environment mapping for the target application to map service calls for the target application that originate from application instances executing in a particular application environment of the two or more application environments to be routed to the instance of the target application executing in the target environment in accordance with the endpoint string.

19. The computing system of claim 13, wherein the message including the endpoint string instructs the API gateway to modify the environment mapping for the target application to map service calls for the target application that originate from application instances executing in any application environment of the two or more application environments to be routed to the instance of the target application executing in the target environment in accordance with the endpoint string.

20. Computer-readable storage media storing instructions that, when executed by processing circuitry, cause the processing circuitry to:
generate data representative of a user interface for display via a user device;
receive a selection of a target environment for a target application from the user interface via the user device, wherein the target environment is selected from two or more application environments;
generate an endpoint string for service calls for the target application that indicates a route to an instance of the target application executing in the target environment; and
send a message including the endpoint string to an application programming interface (API) gateway, wherein the message instructs the API gateway to modify an environment mapping for the target application in accordance with the endpoint string such that the environment mapping causes the API gateway to send the service calls for the target application to the instance of the target application executing in the target environment.
